(19) United States
(12) Patent Application Publication
(10) Pub. No.: US 2026/0352261 A1
(43) Pub. Date: Nov. 5, 2026

(54) NFC ANTENNA MODE SWITCHING

(71) Applicant: ASSA ABLOY Level LLC, Redwood City, CA (US)

(72) Inventors: Jordan R. Fountain, Truckee, CA (US); Kenneth D. Goto, Montecito, CA (US); Bjorn Hanks, Redwood City, CA (US); John H. Martin, Redwood City, CA (US); Rafael Send, Redwood City, CA (US)

(21) Appl. No.: 19/656,720

(22) Filed: Apr. 23, 2026

Related U.S. Application Data
(60) Provisional application No. 63/799,162, filed on May 2, 2025.

(51) Int. Cl. H04B 5/43; H02J 50/00

(52) U.S. Cl. CPC H04B 5/43; H02J 50/001

(57) ABSTRACT

Devices and methods incorporating near-field communication (NFC) antenna mode switching are described. An example near-field antenna switching circuit includes an NFC antenna, an NFC module coupled to the NFC antenna, an NFC energy harvester, and a coupling circuit between the NFC antenna and the NFC energy harvester. The coupling circuit can be configured to either couple the NFC energy harvester to the NFC antenna or to isolate the NFC antenna from the NFC energy harvester. In typical operating scenarios, the coupling circuit isolates the NFC energy harvester from the NFC antenna. The NFC module can use the NFC antenna for data communications in that case. In other scenarios, such as during loss of sufficient battery power, the coupling circuit can couple the NFC energy harvester to the NFC antenna for power harvesting. Power harvested from the NFC antenna can be relied upon to perform certain backup operations.

### CROSS-REFERENCE TO RELATED APPLICATIONS

This application claims priority under 35 U.S.C. § 119(e) to U.S. Provisional Application No.: 63/799,162 filed May 2, 2025 entitled “NFC ANTENNA MODE SWITCHING” under Attorney Docket No.: A1174.70284US00, which is hereby incorporated by reference herein in its entirety.

### BACKGROUND

Near-field communication (NFC) is a short-range wireless communications technology for data communications. NFC antennas, readers, interrogators, and related components facilitate data communications between electronic devices over relatively short distances, such as between about 1-10 centimeters. NFC technology achieves data communications through the inductive coupling of modulated radio frequency (RF) energy between antennas (e.g., coil antennas) in proximately-positioned NFC-enabled devices. Many devices, such as cellular phones, identification tags, computer peripherals, keys, readers, door locks, and other devices, include NFC antennas, readers, interrogators, and related components.

### SUMMARY

Devices and methods incorporating near-field communication (NFC) antennas and energy harvesting capability are described. Aspects described herein include devices and methods incorporating NFC mode switching. An example near-field antenna switching circuit includes an NFC antenna, an NFC module coupled to the NFC antenna, an NFC energy harvester, and a coupling circuit between the NFC antenna and the NFC energy harvester. The coupling circuit can be configured to either couple the NFC energy harvester to the NFC antenna or to isolate the NFC antenna from the NFC energy harvester. In typical operating scenarios, the coupling circuit isolates the NFC energy harvester from the NFC antenna. The NFC module can use the NFC antenna for data communications in that case. In other scenarios, such as during loss of sufficient battery power, the coupling circuit can couple the NFC energy harvester to the NFC antenna for power harvesting. Power harvested from the NFC antenna can be relied upon to perform certain backup operations. The coupling circuit can include one or more junction field-effect transistors.

In other aspects, the near-field antenna switching circuit can include a coupling control circuit configured to control operation of the coupling circuit based on a control signal. The control signal can be provided by a controller for a door lock in one example. The circuit can also include a voltage multiplier coupled to the NFC antenna and configured to generate a control bias voltage from power induced on the NFC antenna. The coupling control circuit can be configured to control the operation of the coupling circuit using the control bias voltage. The coupling control circuit can be configured to control the operation of the coupling circuit using the control bias voltage and based on a control signal. The state of the control signal is based on the remaining voltage of a system battery in one example.

In other aspects, the near-field antenna switching circuit can include a voltage multiplier coupled to the NFC antenna and configured to generate a control bias voltage from power induced on the NFC antenna, a voltage reference generator coupled to the NFC antenna and configured to generate a voltage reference based on the power induced on the NFC antenna, and a comparator. The comparator can be configured to control operation of the coupling circuit using the control bias voltage based on a comparison of the voltage reference with a voltage level of a battery.

In another embodiment, a near-field antenna switching circuit method includes electrically isolating an NFC energy harvester from an NFC antenna at a first time and electrically coupling the NFC energy harvester to the NFC antenna at a second time based on an operational parameter. The operational parameter can be based on a control signal from a controller of a door lock in one case. The operational parameter can be based on a result of a comparison between a reference voltage and a voltage level of a battery in another case.

According to some embodiments, there is provided a near-field antenna circuit, comprising: a near-field communication (NFC) antenna; an NFC module coupled to the NFC antenna; an energy harvesting antenna, wherein the NFC antenna and the energy harvesting antenna are nested together; and an energy harvester coupled to the energy harvesting antenna.

In some embodiments, the energy harvesting antenna is nested within the NFC antenna.

In some embodiments, the near-field antenna circuit further comprises detuning circuitry for selectively detuning the energy harvesting antenna or the NFC antenna.

In some embodiments, the detuning circuitry comprises first detuning circuitry coupled to the energy harvesting antenna and second detuning circuitry coupled to the NFC antenna.

In some embodiments, the near-field antenna circuit further comprises at least one battery and wherein the first detuning circuitry is configured such that the energy harvesting antenna is detuned when the voltage of the at least one battery is greater than zero.

In some embodiments, the second detuning circuitry is configured such that the NFC antenna is detuned when the voltage of the at least one battery is equal to zero.

In some embodiments, the detuning circuitry comprises at least one resistor, at least one capacitor, and at least one resistor, and at least one transistor.

In some embodiments, each of the first detuning circuitry and the second detuning circuitry comprise at least one resistor, at least one capacitor, and at least one resistor, and at least one transistor.

In some embodiments, the energy harvester provides auxiliary power for a lock mechanism of a door lock.

In some embodiments, the near-field antenna circuit is coupled to at least one battery of a lock mechanism, the wherein the selective detuning performed by the detuning circuitry is controlled based on a voltage of the at least one battery.

### BRIEF DESCRIPTION OF THE DRAWINGS

Aspects of the present disclosure can be better understood with reference to the following drawings. It is noted that the elements in the drawings are not necessarily to scale, with emphasis instead being placed upon clearly illustrating the principles of the embodiments. In the drawings, like reference numerals designate like or corresponding, but not necessarily the same, elements throughout the several views.

FIG. 1 illustrates an example of a device in near-field communication with a door lock mechanism according to various embodiments described herein.

FIG. 2 illustrates example near-field communication (NFC) circuitry for NFC antenna mode switching according to various embodiments described herein.

FIG. 3 illustrates another example of NFC circuitry according to various embodiments described herein.

FIG. 4 illustrates another example of NFC circuitry according to various embodiments described herein.

FIG. 5 illustrates an example of NFC circuitry having separated NFC and energy harvesting antennas according to various embodiments described herein.

FIG. 6 illustrates an example of NFC circuitry having nested NFC and energy harvesting antennas according to various embodiments described herein.

### DETAILED DESCRIPTION

As noted herein, near-field communication (NFC) is a short-range wireless communications technology for data communications. NFC antennas, readers, interrogators, and related components facilitate data communications between electronic devices over relatively short distances. Some NFC approaches achieve data communications through the inductive coupling of energy between antennas (e.g., coil antennas) in proximately-positioned NFC-enabled devices. Many devices, such as cellular phones, identification and security tags, computer peripherals, keys, readers, door locks, and other devices, include NFC antennas, readers, interrogators, and related components.

NFC technology has applications in device identification, contactless transactions, data exchange, device setup, and other use cases. Industry standards for NFC technologies have defined protocols and connections for a range of different devices and applications. Among others, example operating modes include reader mode, writer mode, reader/writer mod, card emulation mode, wireless charging mode, host card emulation mode, peer-to-peer mode, and secure element based card emulation mode. Depending on the particular application, use case, and devices in which the NFC technology is incorporated, the communication protocols may rely upon different coding techniques for signal modulation, signal demodulation, signal loading, and power transfer.

NFC technology also facilitates wireless power transmission or transfer between devices, permitting battery-free devices and modes of operation. For example, an NFC interrogator device may be capable of inductively coupling a sufficient amount of energy to an NFC tag to permit the battery-free operation of the NFC tag. However, depending on the type of NFC technologies being employed, a single NFC antenna may not be suitable for two or more operating modes or protocols. Two or more separate NFC antennas might be needed for wireless power harvesting and certain modes of NFC data communication, for example. Some embodiments of the technology described herein provide for circuitry having at least one NFC antenna for performing NFC communications and at least one separate harvesting antenna for performing energy harvesting.

There is further provided embodiments where a single NFC antenna is implemented in the circuitry and NFC antenna mode switching is implemented, as is described herein. An example near-field antenna switching circuit includes an NFC antenna, an NFC module coupled to the NFC antenna, an NFC energy harvester, and a coupling circuit between the NFC antenna and the NFC energy harvester. The coupling circuit can be configured to either couple the NFC energy harvester to the NFC antenna or to isolate the NFC antenna from the NFC energy harvester. In typical operating scenarios, the coupling circuit isolates the NFC energy harvester from the NFC antenna. The NFC module can use the NFC antenna for certain data communication modes in that case. In other scenarios, such as during loss of sufficient battery power, the coupling circuit can couple the NFC energy harvester to the NFC antenna for power harvesting. Power harvested from the NFC antenna can be relied upon to perform certain backup operations. The NFC antenna mode switching facilitates the use of a single NFC antenna for a number of different NFC operating modes and avoids the need for two or more NFC antennas in some cases.

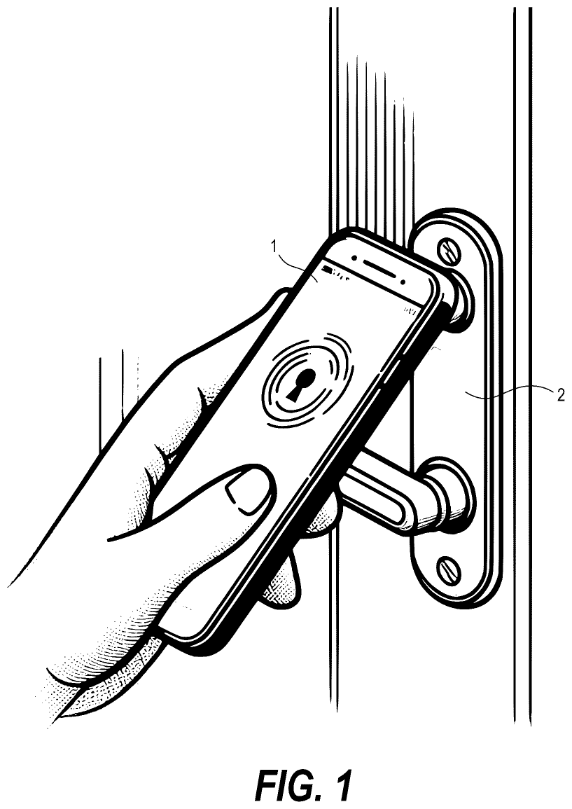

Turning to the drawings, FIG. 1 illustrates an example of a device 1 in near-field communication with a door lock mechanism 2 (also “door lock 2”) according to various embodiments described herein. The concepts of NFC and harvesting antenna circuitry described herein, including the NFC antenna mode switching described herein, can be incorporated into a range of different devices. The door lock 2 incorporates the circuitry and components for NFC and harvesting operations in the examples described below. It should be appreciated, however, that other devices can incorporate the concepts. Thus, although examples are described in the context of the device 1 and the door lock 2, the concepts described herein can be extended to use with other assemblies, devices, and systems, including cellular phones, identification tags, computer peripherals, keys, readers, door locks, and other readers, interrogators, and related components.

The device 1 is within sufficient proximity to the door lock 2 to support NFC data communications between them. Thus, the device 1 can communicate data to the door lock 2, and the door lock 2 can communicate data to the device 1 using NFC data communications. The door lock 2 can receive, store, and process data from the device 1. Based on the type, nature, content, or other characteristics of the data received from the device 1, the door lock 2 can also take certain actions, such as extend or retract a bolt, engage or disengage a locking mechanism, or take other actions to permit or deny doorway access.

Both the device 1 and the door lock 2 can include a battery or related storage means for storing power. NFC data communications between the device 1 and the door lock 2 is supported in part by the power provided from the batteries in typical use cases. The battery in the door lock 2 can also rely upon the power from the battery to perform electro-mechanical locking, unlocking, and related operations. Over time, the power or charge stored in the battery can be depleted, and the battery may ultimately fail to store a sufficient amount of power to support the electro-mechanical locking and unlocking operations of the door lock 2. In such cases, despite proximity between the device 1 and the door lock 2 for NFC data communications between them, the door lock 2 may be unable to both communicate with the device 1 and/or perform the electro-mechanical operations necessary for unlocking due to lack of power. An individual may be unable to unlock the door lock 2 in that case.

However, according to the concepts described herein, the door lock 2 is capable of harvesting power from the device 1 if the battery of the door lock 2 is depleted. More particularly, NFC technology facilitates wireless power transmission or transfer between devices in some modes of operation. Thus, if the battery of the door lock 2 is unable to supply sufficient power for unlocking, then the door lock 2 is capable of harvesting power from the device 1 through the inductive coupling of energy between the NFC antennas between them.

The door lock 2 includes circuitry and components for NFC antenna communications and NFC energy harvesting. In some embodiments, the door lock 2 includes circuitry and components for NFC antenna mode switching described herein. For example, in the NFC mode switching embodiments, the door lock 2 includes a coupling circuit configured to isolate the NFC antenna of the door lock 2 from an NFC energy harvester of the door lock 2. In typical operating scenarios, the coupling circuit isolates the NFC energy harvester from the NFC antenna, to prevent the NFC energy harvester from loading the NFC antenna. The NFC module can use the NFC antenna for data communications in that case. In other scenarios, such as during loss of sufficient battery power, the coupling circuit of the door lock 2 can couple the NFC energy harvester to the NFC antenna of the door lock, so that the door lock can harvest power that is inductively coupled from the device 1 to the door lock 2. Power harvested from the device 1 by the door lock 2 can be used for certain unlocking, locking, and related activities.

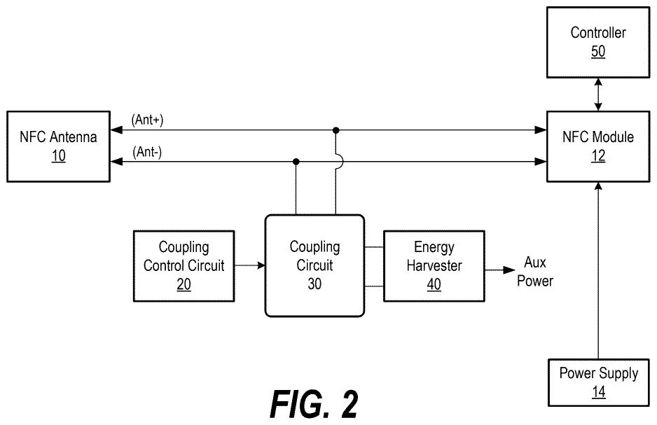

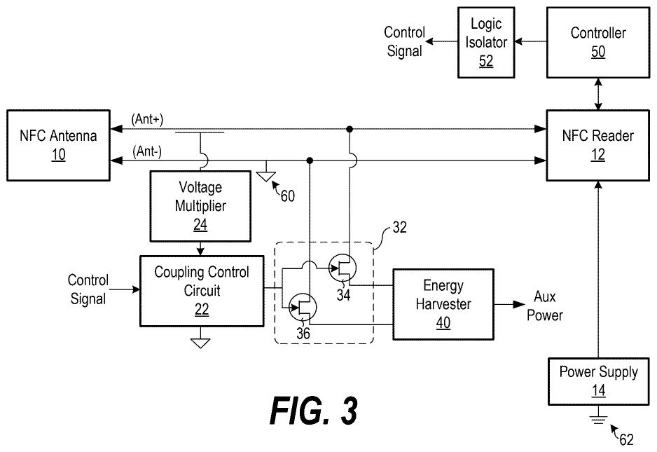

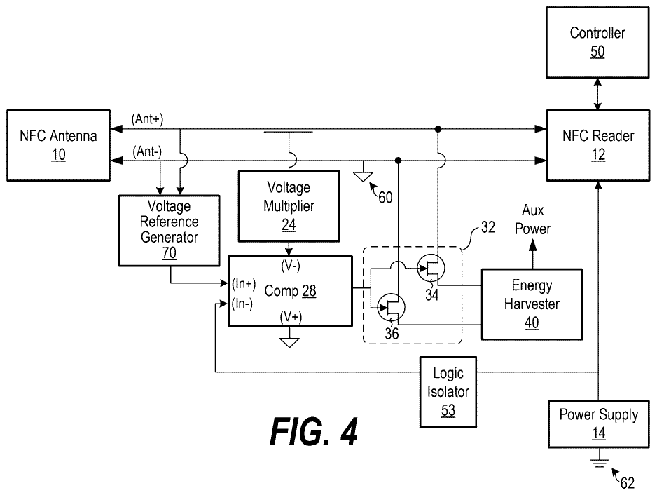

FIG. 2 illustrates NFC circuitry for NFC antenna mode switching. The door lock 2 shown in FIG. 1 can include the circuitry and components shown in FIG. 2. The circuitry shown in FIG. 2 can also be implemented in a range of other devices, however, such as cellular phones, identification tags, computer peripherals, keys, readers, door locks, and other NFC modules, interrogators, and related components. The circuitry in FIG. 2 is also representative and can vary as compared to that shown. The implementation can include other circuit components not shown in FIG. 2, and the implementation can also omit one or more of the components in some cases. Other example implementations are shown in FIGS. 3 and 4.

The circuitry for NFC antenna mode switching includes an NFC antenna 10, an NFC module 12, a power supply 14, a coupling control circuit 20, a coupling circuit 30, an NFC energy harvester 40 (also “energy harvester 40”), and a controller 50. The NFC antenna 10 can be embodied as a loop-type, coil-type, or related antenna suitable for inductive coupling with a corresponding antenna for NFC communications. The NFC antenna 10 can be formed to a variety of shapes, sizes, and profiles depending on the device in which it is implemented. The NFC antenna 10 is electrically coupled to the NFC module 12 by the “Ant+” and “Ant−” couplings (e.g., printed circuit board traces, wires, terminals, etc.) between the NFC antenna 10 and the NFC module 12.

The NFC module 12 can be embodied as one or more NFC communications integrated circuit chips. The NFC module 12 can include processing circuitry, memory, and other integrated circuitry for the implementation of NFC technology communications and protocols. The NFC module 12 can be capable of operating in a number of different operating modes, depending on the use case, such as reader mode, writer mode, reader/writer mode, peer-to-peer mode, etc. Among other operating capabilities, the NFC module 12 is configured to process data based on one or more coding techniques for signal modulation, signal demodulation, or signal modulation and demodulation using the NFC antenna 10.

The NFC module 12 can include processing circuitry to modulate data, demodulate data, or modulate and demodulate data on radio frequency (RF) signals in the industrial, scientific, and medical (ISM) band of 13.56 MHz using the NFC antenna 10. The NFC module 12 is not limited to operation at 13.56 MHz, however, and other carrier frequencies and bands can be relied upon in some cases. More particularly, the NFC module 12 is not limited to operations using the ISO/IEC 14443 Type A, ISO/IEC 14443 Type B, ISO/IEC 15693, ISO/IEC 18092, and the related NFC standards and protocols. The NFC module 12 can include processing circuitry for operations using RF signals at higher and lower frequencies and frequency bands, including those understood in the field to be active RFID operations. The NFC module 12 can receive an RF signal over the NFC antenna 10, demodulate data carried on the RF signal, and communicate the received data to the controller 50 for further processing. In some cases, the NFC module 12 can also receive data for transmission from the controller 50, modulate the data upon an RF signal, and transmit the RF signal using the NFC antenna 10. These and other aspects are described in further detail below.

The power supply 14 can be embodied as a battery, capacitor, or other means for storing or generating charge or power. The power supply 14 can be embodied as any suitable type (e.g., battery chemistry), size (e.g., form factor and dimension), shape, and style of battery, including those that are commercially available and customized for the application. The power supply 14 can also be embodied as a capacitor, a solar cell or solar cell array, or other means for storing or generating charge or power. The power supply 14 provides power to the NFC module 12 and the controller 50 in the example shown in FIG. 2. It should be appreciated, however, that the power supply 14 can also provide power to other components in the door lock 2, such as electro-mechanical components (e.g., motors, gear boxes and gear assemblies, electro-magnetic interlocks, etc.) for locking, unlocking, and related operations. In some cases, the power supply 14 can also provide power to the coupling control circuit 20, the coupling circuit 30, and the energy harvester 40.

The coupling control circuit 20 can be embodied as one or more integrated circuits, discrete circuits, discrete circuit components, or combination of integrated and discrete components that is configured to control the coupling circuit 30 based on one or more operating factors or criteria. As one example, the coupling control circuit 20 can direct the coupling circuit 30 based on a voltage or potential level of the power supply 14. The coupling control circuit 20 can also direct the coupling circuit 30 based on a comparison between the voltage of the power supply 14 and induced potentials on the Ant+ and Ant− terminals. In other examples, the coupling control circuit 20 can direct the coupling circuit 30 based on a control signal from the controller 50 (e.g., at the direction of the controller 50). These and other operating aspects of the coupling control circuit 20 are described below.

The coupling circuit 30 can be embodied as one or more integrated circuits, discrete circuits, discrete circuit components, or combination of integrated and discrete components that is configured to electrically couple the energy harvester 40 to the NFC antenna 10 or, alternatively, to isolate the energy harvester 40 from the NFC antenna 10. In the implementation shown in FIG. 2, the coupling circuit 30 is configured to electrically couple the energy harvester 40 to the Ant+ and Ant− terminals extending between the NFC antenna 10 and the NFC module 12. When the energy harvester 40 is electrically coupled to the Ant+ and Ant− terminals by the coupling circuit 30, the energy harvester 40 acts as a type of load on the NFC antenna 10. When the coupling circuit 30 isolates the energy harvester 40 from the Ant+ and Ant− terminals, the coupling circuit 30 presents a high impedance on the Ant+ and Ant− terminals and the energy harvester 40 does not present a load on the NFC antenna 10.

The energy harvester 40 can be embodied as one or more integrated circuits, discrete circuits, discrete circuit components, or combination of integrated and discrete components that is configured to capture and direct energy that has been inductively coupled onto the NFC antenna 10 and the Ant+ and Ant− terminals. As one example, the energy harvester 40 can be embodied as an integrated circuit that operates as a type of power converter. The energy harvester 40 is configured to capture and convert energy that has been inductively coupled onto the NFC antenna 10 into an auxiliary source of power.

The auxiliary source of power can be used for a range of different purposes. The auxiliary power can be used for unlocking, locking, and related activities of the door lock 2. The auxiliary power can also be used as a supplementary power supply for the controller 50 or other systems or subsystems of the door lock 2 in some cases. The energy harvester 40 can be referenced to the antenna ground reference plane 60 along with the coupling control circuit 22 and other components. Thus, if power from the energy harvester 40 is used as a supplementary power source for the controller 50 or other components that are referenced to the supply ground reference plane 62, then the embodiments can also include a power isolation circuit. The power isolation circuit can be embodied as an isolating charge pump, switching power supply, or related isolation circuit capable of transferring charge across an isolation barrier.

The controller 50 can be embodied as one or more integrated or embedded processing circuits, discrete circuits, discrete circuit components, or a combination of integrated and discrete components. The controller 50 can include a processing circuit and memory for storing computer-readable and executable instructions that, when executed, direct the operation of the door lock 2. The controller 50 can also include integrated logic circuitry to direct the operation of the door lock 2, such as application specific integrated circuits (ASICs), field-programmable gate array (FPGAs), and programmable logic devices (PLDs). Overall, the controller 50 is configured to direct the operation of the door lock 2 shown in FIG. 1 based on computer-readable and executable code (e.g., software), firmware, logic implemented by the controller 50. The controller 50 can be communicatively coupled to the NFC module 12, such as by a serial, parallel, or related data bus, for data communications between them. In some cases, the controller 50 and the NFC module 12 can be integrated together as a single integrated component.

The controller 50 can receive data from the NFC module 12, such as data that has been wirelessly transferred by NFC communications from the device 1 to the door lock 2 through inductive coupling over the NFC antenna 10. Examples of such data include identifier data, key data, and other credential data associated with door locking and unlocking operations. It should be appreciated, however, that the NFC module 12 can demodulate or decode data received over the NFC antenna 10 for any purpose. The controller 50 can also transfer data to the NFC module 12 for transmission over the NFC antenna 10 in some cases.

As noted above, the controller 50 is configured to direct the operation of the door lock 2 shown in FIG. 1. For example, the controller 50 can engage or disengage electro-mechanical components (not shown in FIG. 2) or take other actions to permit or deny doorway access based on data received from the NFC module 12. The controller 50 can also engage or disengage a locking mechanism based on a combination of the data received from the NFC module 12 and software or other logical rules executing on the controller 50 over time.

The power supply 14 provides power to the NFC module 12, the controller 50, and possibly other components in the door lock 2, depending on the operating mode of the NFC circuitry shown in FIG. 2. It is not necessary for the door lock 2 to harvest power from the device 1 through inductive coupling over the NFC antenna 10 when the power supply 14 stores sufficient levels of power to operate the NFC module 12, the controller 50, and other components. When the power supply 14 stores sufficient levels of power, the NFC circuitry in the door lock 2 can operate in a first NFC operating mode, such as in peer-to-peer mode in which power is not harvested using inductive coupling over the NFC antenna 10.

The amount of charge available in the power supply 14 can drop (e.g., be consumed or expended) over time, and the power supply 14 may have insufficient power to support all the operating modes and operations of the NFC circuitry in the door lock 2 in some circumstances. NFC technology facilitates wireless power transmission or transfer between devices, and the NFC antenna 10 can support inductive power transfer from the device 1 to the door lock 2. For that purpose, the energy harvester 40 can harvest energy that is inductively coupled to the door lock 2 over the NFC antenna 10.

However, depending on the mode of NFC technologies being employed, a single NFC antenna may not be suitable for two or more operating modes or protocols operating concurrently. For example, some of the operating modes of the NFC module 12 cannot be supported if energy is concurrently being harvested from the Ant+ and Ant− terminals. The NFC module 12 may be unable to reliably receive and demodulate data on RF signals in peer-to-peer mode, for example, if the energy harvester is electrically coupled to and concurrently presents a load on the Ant+ and Ant− terminals. One solution adopted in some systems is to rely upon two or more NFC antennas to support different NFC operating modes, which increases costs and complexity.

The NFC antenna mode switching concepts described herein facilitate the use of a single NFC antenna for multiple purposes or modes of operation. The coupling circuit 30 can either electrically isolate or electrically couple the energy harvester 40 to the Ant+ and Ant− terminals and the NFC antenna 10. The coupling circuit 30 can electrically isolate or couple the energy harvester 40 to the NFC antenna 10 based on a number of different control factors and thresholds, as directed or determined by the coupling control circuit 20. The coupling circuit 30 can also isolate or couple the energy harvester 40 to the NFC antenna 10 based on a control signal provided from the controller 50.

The coupling control circuit 20 and the coupling circuit 30 can be designed to isolate the energy harvester 40 from the NFC antenna 10 when the power supply 14 provides sufficient power for the operation of the door lock 2. In that case, the load of the energy harvester 40 will not interfere with the operation of the NFC module 12. However, the coupling control circuit 20 can compare a voltage or potential level of the power supply 14 with a given threshold. The coupling control circuit 20 can then provide a logic or control signal to the coupling circuit 30 based on the comparison. The coupling control circuit 20 can direct the coupling circuit 30 to electrically couple the energy harvester 40 to the NFC antenna 10 when the potential level of the power supply 14 drops to or falls below the threshold level. In that way, if the power provided by the power supply 14 drops below a certain level, the energy harvester 40 can be electrically coupled to the NFC antenna 10 for power harvesting. The NFC module 12 may be inoperable, in any case, if the power in the power supply 14 droops too low.

The coupling control circuit 20 is not limited to directing the coupling circuit 30 based on the power level of the power supply 14 in all embodiments. The coupling control circuit 20 can also direct the coupling circuit 30 to isolate or electrically couple the energy harvester 40 and the NFC antenna 10 based on certain periods of time (e.g., timesharing), a control signal from the controller 50, and other operating or control factors.

FIG. 3 illustrates another example of NFC circuitry according to various embodiments described herein. The door lock 2 shown in FIG. 1 can include the circuitry and components shown in FIG. 3, although the circuitry can also be implemented in other devices. The circuitry in FIG. 3 is representative and can vary as compared to that shown. The implementation can include other circuit components not shown in FIG. 3, and the implementation can also omit one or more of the components in some cases. The circuitry for NFC antenna mode switching, as shown in FIG. 3, includes the NFC antenna 10, the NFC module 12, the power supply 14, a coupling control circuit 22, a voltage multiplier 24, a coupling circuit 32, the energy harvester 40, and the controller 50. The circuitry can also include the logic isolator 52 in some cases.

The coupling control circuit 22 shown in FIG. 3 is similar to the coupling control circuit 20 shown in FIG. 2. The coupling control circuit 22 can be embodied as one or more integrated circuits, discrete circuits, discrete circuit components, or combination of integrated and discrete components. The coupling control circuit 22 is configured to output a control signal for the coupling circuit 32. In the example shown in FIG. 3, the coupling control circuit 22 is configured to output a gate control signal for the coupling circuit 32, because the coupling circuit 32 includes two transistors and the output of the control circuit 22 is electrically coupled to the gate terminals of the transistors.

The coupling control circuit 22 is configured to output and control the gate control signal (i.e., control the voltage potential of the gate control signal over time) based on one or more operating factors or criteria. In the example illustrated in FIG. 3, the coupling control circuit 22 is configured to control a voltage potential of the gate control signal over time based on a control signal from the controller 50 (e.g., at the direction of the controller 50). The control signal from the controller 50 to the coupling control circuit 22 can be a logic-level voltage signal that ranges over a first voltage range. The gate control signal output by the coupling control circuit 22 can vary over a different, second voltage range.

The voltage multiplier 24 is electrically coupled between the Ant+ and Ant− terminals and the coupling control circuit 22. The voltage multiplier 24 can be embodied as one or more integrated circuits, discrete circuits, discrete circuit components, or combination of integrated and discrete components. As one example, the voltage multiplier 24 can be embodied as a rectifier of one or more diodes (e.g., a single diode, half bridge diode, or full bridge diode arrangement). The voltage multiplier 24 can also include one or more voltage regulator diodes (e.g., Zener diode), transistor regulators, or other voltage multiplier or regulator devices (e.g., charge pumps, charge converters, etc.).

The voltage multiplier 24 is coupled (e.g., either directly or capacitively) to one or more of the Ant+ and Ant− terminals. In the example shown, the voltage multiplier 24 is coupled to the Ant+ terminal. The voltage multiplier 24 is configured to capture charge from the Ant+ terminal and to generate a control bias voltage from power induced on the NFC antenna 10. As the control bias voltage, the voltage multiplier 24 can generate a voltage of between 0V to −40V, such as −5V, −10V, −20V, −40V, or another negative voltage potential with reference to the logic isolator 52. The voltage multiplier 24 provides the control bias voltage as an input bias to the coupling control circuit 22.

The coupling circuit 32 includes a first transistor 34 and a second transistor 36. The first transistor 34 and the second transistor 36 can be embodied as integrated or discrete transistors. In the example shown, the first transistor 34 and the second transistor 36 are field-effect transistors (FETs), and other types of transistors can be relied upon in some cases. The active channel in an enhancement-mode N-type FET is pinched off (i.e., prevents current flow) at a gate-to-source voltage below the threshold voltage for the device. Thus, applying the same voltage that is present at the source of an enhancement-mode N-type FET to the gate of the FET will turn the device off and prevent current from flowing. Applying a voltage greater than the threshold voltage at the gate of the N-type FET will turn the device on and permit current to flow from the drain to the source. On the other hand, the active channel in a depletion-mode N-type FET is on (i.e., permits current flow) at a gate-to-source voltage of zero. Stated differently, a depletion-mode N-type FET is conductive or conducts in the default state.

In one embodiment, the first transistor 34 and the second transistor 36 are implemented as junction field-effect transistors (i.e., JFET) that operate in depletion mode. The transistors 34 and 36 can be implemented as PN4391 or related transistors in that case. Depending on the gate potential applied to the transistors 34 and 36, the transistors 34 and 36 will either couple the energy harvester 40 to the Ant+ and Ant− terminals and the NFC antenna 10 or isolate the energy harvester 40 from the Ant+ and Ant− terminals. The gate control signal from the coupling control circuit 22 is electrically coupled to the gates of the transistors 34 and 36, to control the coupling circuit 32. In some cases, the gate control signal from the coupling control circuit 22 can be coupled to the gates of the transistors 34 and 36 though a resistor, a resistor divider, or related referencing or coupling components. The use of JFETs for the transistors 34 and 36 facilitates control options even in cases in which the power supply 14 is completely depleted.

In operation, the coupling control circuit 22 is configured to output either a “coupling” gate control signal or an “isolation” gate control signal. If the transistors 34 and 36 are implemented as depletion mode JFETs, the coupling gate control signal can be a signal of lower or negative potential than the antenna ground reference plane 60. For example, the coupling control circuit 22 can output the negative voltage potential generated by the voltage multiplier 24 as the coupling gate control signal. The lower (and possibly negative) potential of the coupling gate control signal will open the channels of the transistors 34 and 36, electrically coupling the energy harvester 40 to the Ant+ and Ant− terminals and the NFC antenna 10. On the other hand, the isolation gate control signal can be a signal of relatively higher potential, such as the potential of the antenna ground reference plane 60 or a higher potential. Such a higher potential isolation gate control signal will close the channels of the transistors 34 and 36, electrically isolating the energy harvester 40 from the Ant+ and Ant− terminals and the NFC antenna 10.

The coupling control circuit 22 can output either the coupling gate control signal or the isolation gate control signal to the coupling circuit 32, over time, based on the control signal from the controller 50 (e.g., at the direction of the controller 50). In that case, the controller 50 can direct the electrical coupling or isolation of the energy harvester 40 to the Ant+ and Ant− terminals and the NFC antenna 10. The controller 50 can thus control the mode of operation or manner in which the NFC antenna 10 is used. The controller 50 can electrically couple the energy harvester 40 to the Ant+ and Ant− terminals for power harvesting by the door lock 2 based on induced potentials from the device 1, among other devices. Alternatively, the controller 50 can electrically isolate the energy harvester 40 from the Ant+ and Ant− terminals for peer-to-peer NFC operating mode using the NFC reader 12. The same NFC antenna 10 can be used for both a first NFC operating mode using the NFC reader 12 and a second NFC mode using the energy harvester 40, without the need for two separate NFC antennas.

When coupled to the Ant+ and Ant− terminals, the energy harvester 40 can capture and convert energy that has been inductively coupled onto the NFC antenna 10 into an auxiliary source of power. The auxiliary source of power can be used for a range of different purposes. The auxiliary power can be used for unlocking, locking, and related activities of the door lock 2. The auxiliary power can also be used as a supplementary power supply for the controller 50 or other systems or subsystems of the door lock 2 in some cases.

In other aspects of the circuit configuration shown in FIG. 3, the coupling control circuit 22, the voltage multiplier 24, the coupling circuit 32, and the energy harvester 40 include circuit components that may “float” in reference potentials along with the antenna ground reference plane 60 based on the extent of energy induced on the NFC antenna 10 and the Ant+ and Ant− terminals. The logic isolator 52 can be embodied as one or more integrated circuits, discrete circuits, discrete circuit components, or combination of integrated and discrete components. The logic isolator 52 is configured to communicate a digital signal over an isolation barrier. For example, the logic isolator 52 is configured to isolate a first control signal from the controller 50, which is referenced to the supply ground reference plane 62, from a second control signal provided to the coupling control circuit 22, which is referenced to the antenna ground reference plane 60. Thus, the logic isolator 52 maintains electrical separation between the antenna ground reference plane 60 and the supply ground reference plane 62, while also permitting the communication of digital signal across the isolation barrier between them.

FIG. 4 illustrates another example of NFC circuitry according to various embodiments described herein. The door lock 2 shown in FIG. 1 can include the circuitry and components shown in FIG. 4, although the circuitry can also be implemented in other devices. The circuitry in FIG. 4 is representative and can vary as compared to that shown. The implementation can include other circuit components not shown in FIG. 4, and the implementation can also omit one or more of the components in some cases. The circuitry for NFC antenna mode switching, as shown in FIG. 4, includes the NFC antenna 10, the NFC module 12, the power supply 14, a comparator 28, the voltage multiplier 24, the coupling circuit 32, the energy harvester 40, the controller 50, a logic isolator 53, and a voltage reference generator 70.

The comparator 28 performs a function similar to the coupling control circuit 22 shown in FIG. 3 and the coupling control circuit 20 shown in FIG. 2. The comparator 28 can be embodied as a low-voltage and low-power integrated comparator. The control bias voltage generated by the voltage multiplier 24 is provided as a negative rail input (V−) to the comparator 28. The antenna ground reference plane 60 is coupled as the positive rail input (V+) to the comparator 28. The power supply 14 is coupled to the inverting input (In−) of the comparator 28. The logic isolator 53 is similar to the logic isolator 52 in FIG. 3 and is coupled between the power supply 14 and the inverting input (In−) of the comparator 28. The logic isolator 53 can provide a type of true/false or logic-level output based on whether or not the charge in the power supply 14 has depleted below a threshold level. The output of the logic isolator 53 can be provided as the inverting input of the comparator 28. The logic isolator 53 maintains electrical separation between the antenna ground reference plane 60 and the supply ground reference plane 62.

The voltage reference generator 70 is electrically coupled between the Ant+ and Ant− terminals and the non-inverting input (In+) of the comparator 28. The voltage reference generator 70 can be embodied as one or more integrated circuits, discrete circuits, discrete circuit components, or combination of integrated and discrete components. The voltage reference generator 70 can be embodied as an arrangement of diodes, capacitors, voltage regulator diodes, transistor regulators, or other low-voltage linear regulators to establish a reference potential. As one example, the voltage reference generator 70 can be embodied as a voltage reference integrated circuit device, such as the ADR225 device of Analog Devices, Inc. of Wilmington, Massachusetts. The output of the voltage reference generator 70 is electrically coupled to the non-inverting input (In+) of the comparator 28. The reference potential generated by the voltage reference generator 70 is compared against the voltage of the power supply 14. Thus, the reference potential generated by the voltage reference generator 70 can range depending on the voltage of the power supply 14.

The comparator 28 is configured to provide an output tied to either the negative rail (V−) or the positive rail (V+) depending on a comparison of the In+ and In− inputs. In one configuration, the comparator 28 can tie the output of the comparator 28 to the negative rail (V−) as the isolation gate control signal when the potential of the power supply 14 at the In— input is greater than the voltage generated by the voltage reference generator 70 at the In+ input. The lower potential at the negative rail (V−) thus acts as the isolation gate control signal for the transistors 34 and 36 and will close (i.e., pinch off) the channels of the transistors 34 and 36, electrically isolating the energy harvester 40 from the Ant+ and Ant− terminals and the NFC antenna 10. On the other hand, the comparator 28 can tie the output of the comparator 28 to the positive rail (V+) as the coupling gate control signal when the potential of the power supply 14 at the In− input is less than the voltage generated by the voltage reference generator 70 at the In+ input. The potential of the antenna ground reference plane 60 thus acts as a coupling gate control signal for the transistors 34 and 36 and will open (i.e., permit current flow) the channels of the transistors 34 and 36, electrically coupling the energy harvester 40 to the Ant+ and Ant− terminals and the NFC antenna 10.

The comparator 28 can provide either the coupling gate control signal or the isolation gate control signal to the coupling circuit 32, over time, based on a comparison of the potential of the power supply 14 to that of the voltage reference generator 70. The voltage reference generator 70 can be configured to provide a voltage reference of 2.5V, as one example. In that case, when the potential of the power supply 14 is greater than 2.5V, the comparator 28 can provide the isolation gate control signal to the transistors 34 and 36, which will close the channels of the transistors 34 and 36 and electrically isolate the energy harvester 40 from the Ant+ and Ant− terminals and the NFC antenna 10. Alternatively, when the potential of the power supply 14 falls below 2.5V, the comparator 28 can provide the coupling gate control signal to the transistors 34 and 36, which will open the channels of the transistors 34 and 36 and electrically couple the energy harvester 40 to the Ant+ and Ant− terminals and the NFC antenna 10 for energy harvesting.

As in the other examples described herein, the same NFC antenna 10 can be used for both a first NFC operating mode using the NFC reader 12 and a second NFC mode using the energy harvester 40, without the need for two separate NFC antennas. When coupled to the Ant+ and Ant− terminals, the energy harvester 40 can capture and convert energy that has been inductively coupled onto the NFC antenna 10 into an auxiliary source of power. The auxiliary source of power can be used for a range of different purposes. The auxiliary power can be used for unlocking, locking, and related activities of the door lock 2. The auxiliary power can also be used as a supplementary power supply for the controller 50 or other systems or subsystems of the door lock 2 in some cases.

Other embodiments of NFC antenna mode switching include a method for near-field antenna switching using the circuitry illustrated in FIGS. 2-4. An example method includes electrically isolating an NFC energy harvester from an NFC antenna at a first time and electrically coupling the NFC energy harvester to the NFC antenna at a second time based on one or more operational parameters. With reference to FIGS. 2-4, one of the coupling circuits 30 or 32 can be relied upon to electrically couple or isolate the energy harvester 40 and the NFC antenna 10 with respect to each other, as described above. Further, the coupling control circuit 20 shown in FIG. 2, the coupling control circuit 22 shown in FIG. 3, or the comparator 28 shown in FIG. 4 can direct the operation of the coupling circuits 30 or 32 over time, to electrically couple and/or isolate the energy harvester 40 and the NFC antenna 10 with respect to each other.

The energy harvester 40 and the NFC antenna 10 can be isolated from and coupled to each other, in alternate fashion, over time as needed. The energy harvester 40 and the NFC antenna 10 can also be isolated from and coupled to each based on control signals, the evaluation of operational parameters, and other considerations. The control signals can include a control signal from the controller 50, for example, as described in connection with FIG. 3. The evaluation of operational parameters can include a comparison of the power remaining in the power supply 14 against a reference voltage derived from the NFC antenna 10, for example, as described in connection with FIG. 4. The use of other types of control signals, the evaluation of other operational parameters, and other factors for antenna mode switching are within the scope of the embodiments.

As described herein, some embodiments of the technology provide for NFC antenna circuits having separate antennas for NFC communications and energy harvesting. Such NFC antenna circuits may be coupled to a door lock. For example, the energy harvester of the NFC antenna circuits described herein may be configured to provide auxiliary power for a lock mechanism of a door lock.

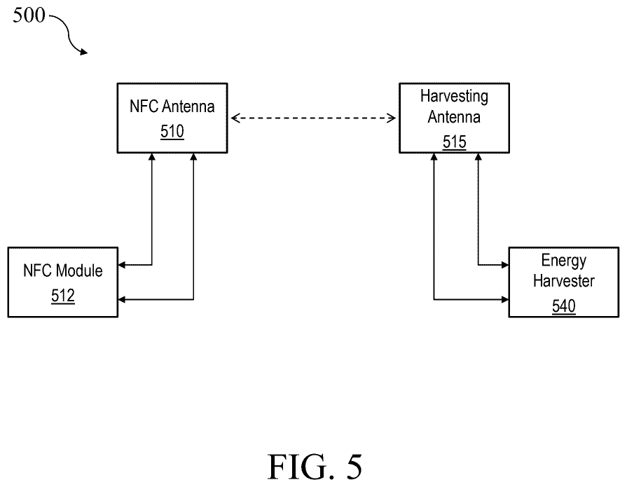

FIG. 5 illustrates an example of NFC circuitry having separated NFC and energy harvesting antennas according to various embodiments described herein. In particular, the NFC circuitry 500 shown in FIG. 5 includes an NFC antenna 510 configured to facilitate NFC communications and a harvesting antenna 515 configured to receive energy for energy harvesting operations.

The NFC antenna 510 may be configured in the same or similar way as NFC antenna 10 described herein. The NFC antenna 510 is coupled to an NFC module 512. The NFC module 512 may be configured in the same or similar way as NFC module 12 described herein.

The harvesting antenna 515 is coupled to energy harvester 540. Energy harvester 540 may be configured in the same or similar way as energy harvester 40. The NFC circuitry 500 may include one or more additional components, such as one or more of the components of the circuitry shown in FIG. 2 (e.g., controller, power supply). Such components may be configured in the same or similar manner as the components of the circuitry shown in FIG. 2. Accordingly, further description of these components is omitted.

In the illustrated embodiment of FIG. 5, the harvesting antenna 515 and the NFC antenna 510 are separated by a sufficient distance such that the NFC antenna 510 and harvesting antenna 515 do not interfere with each other and/or minimally interfere with each other. This configuration requires a larger circuitry footprint, as distance is needed to separate the NFC antenna 510 and harvesting antenna 515.

In some instances, increasing the footprint of the NFC circuitry is not possible. For example, when the NFC circuitry is implemented in an electronic door lock, the size of the electronic door lock may be too small to accommodate the necessary separation between antennas. Where the antennas are not separated sufficiently, detuning circuitry may instead be used to reduce the interference between the antennas. Accordingly, there is provided herein NFC circuitry having an NFC antenna, an energy harvesting antenna, and detuning circuitry for detuning the antennas. In some embodiments, the NFC antenna and the energy harvesting antenna may be nested together.

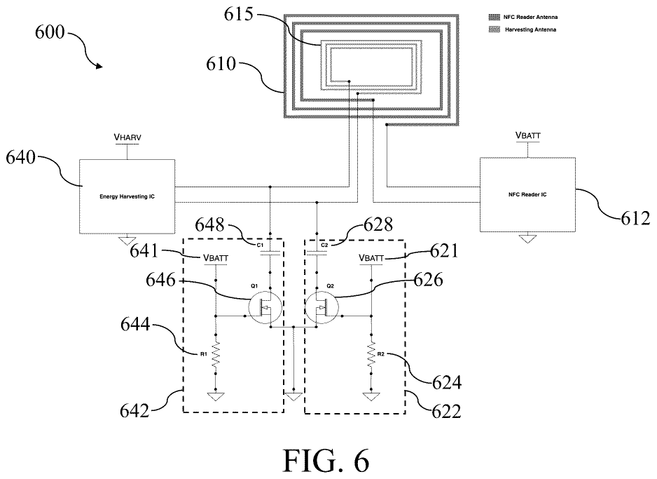

FIG. 6 illustrates an example of NFC circuitry having nested NFC and energy harvesting antennas according to various embodiments described herein. The NFC circuitry 600 illustrated in FIG. 6 includes two separate antennas: NFC antenna 610 configured to facilitate NFC communications and a harvesting antenna 615 configured to receive energy for energy harvesting operations. The NFC antenna 610 and energy harvesting antenna 615 may be configured in the same or similar manner as NFC antenna 510, energy harvesting antenna 515, and/or NFC antenna 10.

The NFC antenna 610 is coupled to an NFC module 612. The NFC module 612 may be configured in the same or similar way as NFC module 12 described herein. The energy harvesting antenna 615 is coupled to energy harvester 640. Energy harvester 640 may be configured in the same or similar way as energy harvester 40. The NFC circuitry 600 may include one or more additional components, such as one or more of the components of the circuitry shown in FIG. 2 (e.g., controller, power supply). Such components may be configured in the same or similar manner as the components of the circuitry shown in FIG. 2. Accordingly, further description of these components is omitted.

As shown in FIG. 6, NFC antenna 610 and energy harvesting antenna 615 are nested together. In particular, the NFC antenna 610 is larger than the energy harvesting antenna 615, and the energy harvesting antenna 615 is nested within the NFC antenna 610. However, in other embodiments, the NFC antenna 610 may be nested within the energy harvesting antenna 615. The nesting of the NFC antenna 610 and the energy harvesting antenna 615 together decreases the overall size of the NFC circuitry 600, enabling the NFC circuitry to occupy a relatively small footprint. In this way, the NFC circuitry 600 may be implemented in devices, including electronic locks, having a relatively small size and/or minimal space therein for circuitry. In the embodiment shown in FIG. 6, the antennae are concentric rectangular spirals, such that energy harvesting antenna 615 is concentrically nested within the NFC antenna 610. However, it should be appreciated that the techniques are not limited to concentric rectangular spirals. For example, the antennae could be nested spirals (but not concentric spirals), the antennae could be of non-rectangular spirals (e.g., circular, triangular, etc.) and/or may be patterned in other nested configurations.

Given the close proximity of the NFC antenna 615 and energy harvesting antenna 610, the NFC circuitry 600 further comprises detuning circuitry configured to detune the antennas. In particular, the detuning circuitry is configured to selectively detune the energy harvesting antenna 615 or the NFC antenna 610. For example, when it is desired to use the NFC antenna 610 to transmit and/or receive NFC communications, the detuning circuitry is configured such that the energy harvesting antenna 615 is detuned. On the other hand, when it is desired to use the energy harvesting antenna 615 to harvest energy, the detuning circuitry is configured such that the NFC antenna 610 is detuned. In this way, the energy harvesting antenna 615 and the NFC antenna 610 are selectively detuned so as to reduce interference between the antennas.

In the illustrated embodiment of FIG. 6, the detuning circuitry includes first detuning circuitry 642 and second detuning circuitry 622. The first detuning circuitry 642 is coupled to the energy harvesting antenna 615 and is configured to detune the energy harvesting antenna 615. The second detuning circuitry 622 is coupled to the NFC antenna 610 and is configured to detune the NFC antenna 610.

As shown in FIG. 6, the detuning circuitry includes at least one resistor, at least one capacitor, and at least one transistor. In particular, the first detuning circuitry 642 vcoupled to the energy harvesting antenna 615 includes a resistor 644, a capacitor 648, a transistor 646, and a voltage source or battery 641. The second detuning circuitry 622 includes a resistor 624, a transistor 646, a capacitor 628, and a voltage source or battery 628.

The selective detuning of the NFC antenna 610 and the energy harvesting antenna 615 may be performed based on a voltage of the battery. For example, the first detuning circuitry is configured such that the energy harvesting antenna is detuned when the voltage of the at least one battery is greater than zero. By contrast, the second detuning circuitry is configured such that the NFC antenna is detuned when the voltage of the at least one battery is equal to zero. In some embodiments, the voltage source or battery may be a battery of a lock mechanism.

For example, under normal battery power operation (e.g., when the battery voltage is greater than zero), the energy harvesting antenna 615 is detuned. This is facilitated by adding capacitance to the antenna input of the energy harvester 640. The voltage of the battery 641 will maintain the transistors 646, 626 which are MOSFETs in the illustrated embodiment in their ON state. With the transistors 646, 626 in their ON state, the capacitors 648, 628 are effectively connected to ground.

When the battery is dead (e.g., when the battery voltage is close to and/or equal to zero), the energy harvesting antenna 615 is active and the NFC antenna 610 is detuned. The voltage of batteries 648, 628 will be equal to zero. The transistors 646, 626 are in their OFF state. Resistors 644, 624 are implemented on the input of the transistors 646, 626, respectively, to ensure that the transistors 646, 626 remain in the OFF state. The energy harvesting antenna 615 is no longer detuned because the capacitance has no effect on the energy harvesting antenna 615.

When two components are described as being “connected to” or “coupled to” each other, the components can be electrically coupled to each other, with or without other components being electrically coupled and intervening between them. When two components are described as being “directly connected to” or “directly coupled to” each other, the components can be electrically coupled to each other, without other components being electrically coupled between them.

Terms such as “a,” “an,” “the,” and “said” are used to indicate the presence of at least one element or component (e.g., one or, alternatively, more than one), unless particularly identified as one and only one (e.g., single or singular one). The terms “comprise,” “include,” “have,” “contain,” and their variants are open ended and may include or encompass additional elements, components, etc., in addition to the listed elements, components, etc., unless otherwise specified. The terms “first,” “second,” etc. are used only as distinguishing or separating labels, rather than a limitation of a number of the components, unless particularly used as a numerical quantifier.

The components described herein can be embodied in hardware, software, or a combination of hardware and software. If embodied in software, each component or element can represent a module or group of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

If embodied as hardware, the components described herein can be implemented as one or more integrated circuits, discrete circuits, discrete circuit components, or combination of integrated and discrete components. The integrated circuits can include one or more semiconductor devices integrated onto one or more semiconductor chips, one or more microprocessors, one or more discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

In integrated implementations, one or more of the circuitry components, including for example, NFC reader 12, the coupling control circuit 20, the coupling control circuit 22, the comparator 28, the voltage multiplier 24, the coupling circuit 30, the transistors 34 and 36, the power harvester 40, and the voltage reference generator 70 can be implemented together as a single integrated circuit or ASIC. Those components can be implemented together on a single semiconductor die and packaged in a single package in some cases. In other examples, a subset of the components can be implemented on a first ASIC and another subset of the components can be implemented on a second ASIC.

The controller 50 can include at least one processing circuit. Such a processing circuit can include, for example, one or more processors and one or more storage or memory devices coupled to a local interface. The local interface can include, for example, a data bus with an accompanying address/control bus or any other suitable bus structure. The storage or memory devices can store data or components that are executable by the processors of the processing circuit.

Also, one or more or more of the components described herein that include software or program instructions can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

The features, structures, or characteristics described above may be combined in one or more embodiments in any suitable manner, and the features discussed in the various embodiments are interchangeable in many cases. In the foregoing description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although embodiments have been described herein in detail, the descriptions are by way of example. The features of the embodiments described herein are representative and, in alternative embodiments, certain features and elements can be added or omitted. Additionally, modifications to aspects of the embodiments described herein can be made by those skilled in the art without departing from the spirit and scope of the present invention defined in the following claims, the scope of which are to be accorded the broadest interpretation so as to encompass modifications and equivalent structures.

Therefore, the following is claimed:

1. A near-field antenna switching circuit, comprising:
a near-field communication (NFC) antenna;
an NFC module coupled to the NFC antenna;
an NFC energy harvester; and
a coupling circuit between the NFC antenna and the NFC energy harvester, the coupling circuit being configured to either couple the NFC energy harvester to the NFC antenna or to isolate the NFC antenna from the NFC energy harvester.

2. The near-field antenna switching circuit according to claim 1, further comprising a coupling control circuit configured to control operation of the coupling circuit based on a control signal.

3. The near-field antenna switching circuit according to claim 2, wherein the control signal is provided by a controller for a door lock.

4. The near-field antenna switching circuit according to claim 2, further comprising a voltage multiplier coupled to the NFC antenna and configured to generate a control bias voltage from power induced on the NFC antenna.

5. The near-field antenna switching circuit according to claim 4, wherein the coupling control circuit is configured to control the operation of the coupling circuit using the control bias voltage.

6. The near-field antenna switching circuit according to claim 5, wherein the coupling control circuit is configured to control the operation of the coupling circuit using the control bias voltage and based on a control signal.

7. The near-field antenna switching circuit according to claim 6, wherein a state of the control signal is based on a remaining voltage of a system battery.

8. The near-field antenna switching circuit according to claim 1, further comprising:
a voltage multiplier coupled to the NFC antenna and configured to generate a control bias voltage from power induced on the NFC antenna;
a voltage reference generator coupled to the NFC antenna and configured to generate a voltage reference based on the power induced on the NFC antenna; and
a comparator, the comparator configured to control operation of the coupling circuit using the control bias voltage based on a comparison of the voltage reference with a voltage level of a battery.

9. The near-field antenna switching circuit according to claim 1, wherein the NFC energy harvester provides auxiliary power for a lock mechanism.

10. The near-field antenna switching circuit according to claim 1, wherein the coupling circuit comprises at least one junction field-effect transistor.

11. A near-field antenna switching circuit method, comprising:
electrically isolating an NFC energy harvester from an NFC antenna at a first time; and
electrically coupling the NFC energy harvester to the NFC antenna at a second time based on an operational parameter.

12. The near-field antenna switching circuit method of claim 11, wherein the operational parameter comprises a control signal from a controller.

13. The near-field antenna switching circuit method of claim 11, wherein the operational parameter comprises a result of a comparison between a reference voltage and a voltage level of a battery.

14. A near-field antenna switching circuit, comprising:
a near-field communication (NFC) antenna;
an NFC module coupled to the NFC antenna;
an NFC energy harvester; and
a coupling circuit between the NFC antenna and the NFC energy harvester, the coupling circuit being configured to either couple the NFC energy harvester to the NFC antenna or to isolate the NFC antenna from the NFC energy harvester based on a comparison between a reference voltage and a voltage level of a battery.

15. The near-field antenna switching circuit according to claim 14, further comprising a voltage multiplier coupled to the NFC antenna and configured to generate a control bias voltage from power induced on the NFC antenna.

16. The near-field antenna switching circuit according to claim 15, further comprising a coupling control circuit configured to control operation of the coupling circuit using the control bias voltage.

17. The near-field antenna switching circuit according to claim 15, further comprising:
a voltage multiplier coupled to the NFC antenna and configured to generate a control bias voltage from power induced on the NFC antenna; and
a voltage reference generator coupled to the NFC antenna and configured to generate a voltage reference based on the power induced on the NFC antenna.

18. The near-field antenna switching circuit according to claim 17, further comprising:
a comparator, the comparator configured to control operation of the coupling circuit using the control bias voltage based on a comparison of the voltage reference with a voltage level of a battery.

19. The near-field antenna switching circuit according to claim 14, wherein the NFC energy harvester provides auxiliary power for a lock mechanism.

20. A near-field antenna circuit, comprising:
a near-field communication (NFC) antenna;
an NFC module coupled to the NFC antenna;
an energy harvesting antenna, wherein the NFC antenna and the energy harvesting antenna are nested together; and
an energy harvester coupled to the energy harvesting antenna.
